(19) United States
(12) Patent Application Publication
(10) Pub. No.: US 2024/0158880 A1
(43) Pub. Date: May 16, 2024

(54) MICRO-MOLYBDENUM-TYPE WEATHERING BRIDGE STEEL PLATE AND PREPARATION METHOD THEREOF

(71) Applicant: NANJING IRON & STEEL CO., LTD., Nanjing (CN)

(72) Inventors: Yixin HUANG, Nanjing (CN); Mingliang QIAO, Nanjing (CN); Baijie ZHAO, Nanjing (CN); Chunxia TANG, Nanjing (CN); Jun WANG, Nanjing (CN); Qiang CUI, Nanjing (CN); Linheng CHEN, Nanjing (CN); Yuqun YIN, Nanjing (CN); Tao LIU, Nanjing (CN); Yurong QIN, Nanjing (CN); Lingming MENG, Nanjing (CN)

(73) Assignee: NANJING IRON & STEEL CO., LTD., Nanjing (CN)

(21) Appl. No.: 18/281,588

(22) PCT Filed: Nov. 17, 2021
(86) PCT No.: PCT/CN2021/131106

§ 371 Date: Sep. 12, 2023

(30) Foreign Application Priority Data
Sep. 17, 2021 (CN) 202111091034.2

(51) Int. Cl. C21D 9/46; B22D 11/00; C21D 1/18; C21D 1/84; C21D 6/00; C21D 8/02; C22C 33/04; C22C 38/00; C22C 38/02; C22C 38/04; C22C 38/06; C22C 38/42; C22C 38/44; C22C 38/46; C22C 38/48; C22C 38/50

(52) U.S. Cl. CPC C21D 9/46; B22D 11/001; C21D 1/18; C21D 1/84; C21D 6/004; C21D 6/005; C21D 6/008; C21D 8/0205; C21D 8/021; C21D 8/0226; C21D 8/0263; C22C 33/04; C22C 38/002; C22C 38/02; C22C 38/04; C22C 38/06; C22C 38/42; C22C 38/44; C22C 38/46; C22C 38/48; C22C 38/50; C21D 2211/002; C21D 2211/005

(57) ABSTRACT

A micro-molybdenum-type weathering bridge steel plate disclosed by the present invention is characterized in that the steel plate is smelted from the following components by weight: C: 0.05-0.08%, Si: 0.30-0.50%, Mn: 1.25-1.35%, P: 0.010-0.014%, S≤0.003%, Nb: 0.020-0.030%, Ti: 0.010-0.020%, V: 0.040-0.050%, Cu: 0.25-0.40%, Ni: 0.25-0.35%, Cr: 0.45-0.55%, Mo: 0.03-0.08%, Alt: 0.020-0.040%, and the balance from Fe and impurities. Less content of molybdenum reduces the production cost of the steel plate, the yield strength of the steel plate is 500-600 MPa, the yield strength ratio is ≤0.85, and the maximum thickness of the steel plate can reach 80 mm.

### TECHNICAL FIELD

The present invention relates to a steel plate and a preparation method thereof, and particularly relates to a micro-molybdenum-type weathering bridge steel plate and a preparation method thereof.

### BACKGROUND ART

At present, weathering steel has been widely used for bridge design and construction due to its low cost, simple maintenance, and environmental protection throughout the design life cycle. The yield strength ratio is an important index used to measure the safety of steel structure bridge construction. If the yield strength ratio is too high, the steel will easily be broken after yielding under stress, while the steel with a low yield strength ratio can have a higher strain after yielding under stress, thus obtaining higher tensile strength. However, as its strength increases, it is increasingly difficult to control the yield strength ratio at lower levels.

### SUMMARY

An objective of the present invention is to provide a micro-molybdenum-type weathering bridge steel plate, which has high strength, maintains a low yield strength ratio, and improves its impact toughness and plasticity.

The micro-molybdenum-type weathering bridge steel plate according to the present invention is characterized in that the steel plate is smelted from the following components by weight: C: 0.05-0.08%, Si: 0.30-0.50%, Mn: 1.25-1.35%, P: 0.010-0.014%, S≤0.003%, Nb: 0.020-0.030%, Ti: 0.010-0.020%, V: 0.040-0.050%, Cu: 0.25-0.40%, Ni: 0.25-0.35%, Cr: 0.45-0.55%, Mo: 0.03-0.08%, Alt: 0.020-0.040%, and the balance from Fe and impurities.

The effect of each metal component and content in the present invention is as follows:

Cu: 0.25%-0.40%, where copper plays a role in solid solution strengthening of steel, and an appropriate amount of copper can improve the strength and corrosion resistance of steel without affecting the toughness of steel.

Cr: 0.45%-0.55%, where chromium can improve the yield strength of steel, but will have a negative impact on its yield strength ratio; at the same time, the reserves of chromium elements are low, so this patent reduces the content of chromium and replaces it with other metals.

Mo: 0.03%-0.08%, where as a solid solution strengthening metal, molybdenum can greatly improve the hardenability and hot hardness of steel, thereby significantly reducing temper brittleness. The present invention improves the strength of the steel plate by controlling the rolling process, reduces the content of molybdenum in the steel plate, and thus reduces the production cost of 485 MPa grade weathering bridge steel.

Further, the steel plate is composed of granular bainite and a small amount of ferrite, and the metallographic structure composed of granular bainite and a small amount of ferrite is fine and uniform, which is beneficial for the steel plate to keep good plasticity and toughness, and maintaining strength and also a low yield strength ratio.

Further, the production process of the steel plate includes smelting, continuous casting, heating, rolling, and tempering. It is characterized in that the rolling process is two-stage rolling. The rough rolling (RR) temperature is 950-1150° C., and the initial rolling temperature (IRT) and the finishing rolling temperature (FRT) of finish rolling (FR) are 850-900° C. and 800-850° C., respectively; after hot rolling, the steel plate is cooled by laminar flow, and the cooling rate is 5-20° C./s. The smaller cooling rate enables to obtain more ductile structures in the steel plate, which can improve the impact toughness and shaping of the steel plate.

Further, the continuous casting process is a casting process of dynamic soft reduction, and the continuous casting under dynamic soft reduction can improve the internal quality of a casting blank and reduce the level of macrosegregation and microsegregation in the center of the casting blank.

Further, the smelting process includes Ladle Furnaces (LF) refining process and Ruhrstahl Heraeus (RH) vacuum treatment process. LF refining is used to deeply control impurities in steel to avoid negative impacts of large inclusions on steel toughness; RH vacuum treatment process is used to improve the purity of molten steel and ensure the quality of molten steel, thus laying a foundation for subsequent improvement of the internal quality of the casting blank.

Further, the heating temperature of the casting blank in the heating process is 1160-1200° C., and heating is performed in a furnace for 235-350 min.

Further, the temperature of the tempering process is 500-550° C. The tempering time is 50-150 min.

Beneficial effects: 1. Improve the properties of the steel plate: the yield strength of the steel plate prepared according to the present invention is 500-600 MPa, the yield strength ratio is less than or equal to 0.85, the impact energy at −23° C. at a quarter of the plate thickness is greater than or equal to 240 J, the elongation is greater than or equal to 20%, the non-plastic transformation temperature of T_{NDT} is −50° C., and the maximum thickness of the steel plate can reach 80 mm. 2. Saving the cost of the steel plate: the present invention combines the fine-tuning of the steel plate composition with the rolling method, which reduces the use of precious metals while improving the performance, and saves the material cost during production.

### BRIEF DESCRIPTION OF THE DRAWINGS

FIG. 1 is a microstructure diagram of a steel plate according to Embodiment 1; and.

FIG. 2 is a microstructure diagram of a steel plate according to Embodiment 2.

### DETAILED DESCRIPTION OF THE EMBODIMENTS

The technical solution of the present invention will be further described below with reference to the accompanying drawings.

### Embodiment 1

A micro-molybdenum-type weathering bridge steel plate of this embodiment has a thickness of 16 mm, and the weight percentages of its components are as follows: C: 0.05%, Si: 0.50%, Mn: 1.29%, P: 0.010%, S: 0.0014%, Alt: 0.040%, Nb: 0.030%, V: 0.040%, Ti: 0.020%, Ni: 0.25%, Cr: 0.45%, Mo: 0.02%, Cu: 0.40%, and the balance from Fe and inevitable impurities.

First, after the converter blowing, the steel plate is refined by use of Ladle Furnaces (LF) to adjust the alloy composition and then is subject to RH vacuum treatment to improve the purity of molten steel, and then the dynamic soft reduction technology is used for continuous casting; a 260 mm thick casting blank is heated to 1200° C., and the tapping temperature is 1200° C. after 283 min; after the steel is released from the furnace, the steel enters the stage of controlled rolling and controlled cooling, and the rolling is divided into rough rolling and finish rolling. The rough rolling (RR) temperature is 1091° C., and the initial rolling temperature (IRT) and the finishing rolling temperature (FRT) of finish rolling (FR) are 890° C. and 852° C., respectively. After rolling, laminar cooling is performed, the self-tempering temperature after cooling is 538° C., and the cooling rate is 20° C./s.

The properties of the steel plate made based on this composition and process are shown in Tables 1 to 3.

### Embodiment 2

A micro-molybdenum-type weathering bridge steel plate of this embodiment has a thickness of 32 mm, and the weight percentages of its components are as follows: C: 0.07%, Si: 0.38%, Mn: 1.30%, P: 0.012%, S: 0.0010%, Alt: 0.036%, Nb: 0.025%, V: 0.047%, Ti: 0.014%, Ni: 0.32%, Cr: 0.50%, Mo: 0.05%, Cu: 0.28%, and the balance from Fe and inevitable impurities.

First, after the converter blowing, the steel plate is refined by use of Ladle Furnaces (LF) to adjust the alloy composition and then is subject to RH vacuum treatment to improve the purity of molten steel, and then the dynamic soft reduction technology is used for continuous casting; a 260 mm thick casting blank is heated to 1169° C., and the steel is released from the furnace after heating for 281 min; after the steel is released from the furnace, the steel enters the stage of controlled rolling and controlled cooling, and the rolling is divided into rough rolling and finish rolling. The rough rolling (RR) temperature is 1166° C., and the initial rolling temperature (IRT) and the finishing rolling temperature (FRT) of finish rolling (FR) are 860° C. and 819° C., respectively. After rolling, laminar cooling is performed, the cooling temperature is 547° C., and the cooling rate is 12.6° C./s.

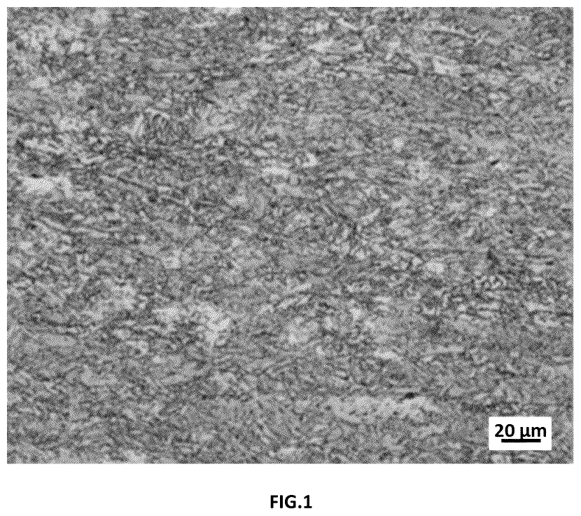

The properties of the steel plate made based on this composition and process are shown in Tables 1 to 3, and the microstructure and morphology are shown in FIG. 1.

### Embodiment 3

A micro-molybdenum-type weathering bridge steel plate of this embodiment has a thickness of 32 mm, and the weight percentages of its components are as follows: C: 0.06%, Si: 0.45%, Mn: 1.28%, P: 0.012%, S: 0.0012%, Alt: 0.038%, Nb: 0.030%, V: 0.045%, Ti: 0.012%, Ni: 0.29%, Cr: 0.48%, Mo: 0.06%, Cu: 0.32%, and the balance from Fe and inevitable impurities.

First, after the converter blowing, the steel plate is refined by use of Ladle Furnaces (LF) to adjust the alloy composition and then is subject to RH vacuum treatment to improve the purity of molten steel, and then the dynamic soft reduction technology is used for continuous casting; a 260 mm thick casting blank is heated to 1168° C., and the steel is released from the furnace after heating for 279 min; after the steel is released from the furnace, the steel enters the stage of controlled rolling and controlled cooling, and the rolling is divided into rough rolling and finish rolling. The rough rolling (RR) temperature is 1119° C., and the initial rolling temperature (IRT) and the finishing rolling temperature (FRT) of finish rolling (FR) are 858° C. and 809° C., respectively. After rolling, laminar cooling is performed, the cooling temperature is 549° C., and the cooling rate is 12.5° C./s.

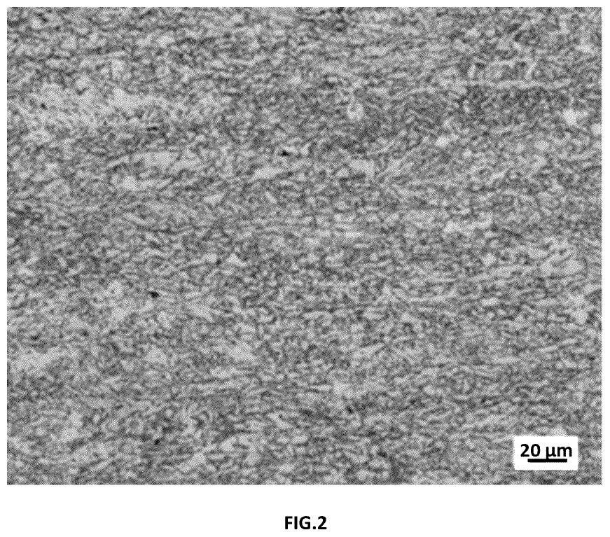

The properties of the steel plate made based on this composition and process are shown in Tables 1 to 3, and the microstructure and morphology are shown in FIG. 2.

### Embodiment 4

A micro-molybdenum-type weathering bridge steel plate of this embodiment has a thickness of 65 mm, and the weight percentages of its components are as follows: C: 0.08%, Si: 0.32%, Mn: 1.35%, P: 0.014%, S: 0.0013%, Alt: 0.025%, Nb: 0.028%, V: 0.050%, Ti: 0.010%, Ni: 0.35%, Cr: 0.55%, Mo: 0.08%, Cu: 0.26%, and the balance from Fe and inevitable impurities.

First, after the converter blowing, the steel plate is refined by use of Ladle Furnaces (LF) to adjust the alloy composition and then is subject to RH vacuum treatment to improve the purity of molten steel, and then the dynamic soft reduction technology is used for continuous casting; a 260 mm thick casting blank is heated to 1193° C., and the steel is released from the furnace after heating for 267 min; after the steel is released from the furnace, the steel enters the stage of controlled rolling and controlled cooling, and the rolling is divided into rough rolling and finish rolling. The rough rolling (RR) temperature is 1120° C., and the initial rolling temperature (IRT) and the finishing rolling temperature (FRT) of finish rolling (FR) are 855° C. and 805° C., respectively. After rolling, laminar cooling is performed, the cooling temperature is 500° C., and the cooling rate is 7.5° C./s.

The properties of the steel plate made based on this composition and process are shown in Tables 1 to 3.

TABLE 1
Tensile Properties

| | | Tensile properties | | | |
|---|---|---|---|---|---|
| | | | | | Yield |
| | Thickness, | Yield | Tensile | Elonga- | strength |
| Embodiment | mm | strength | strength/MPa | tion/% | ratio |
| Embodiment 1 | 16 | 600 | 710 | 28 | 0.85 |
| | | 555 | 660 | 32 | 0.84 |
| Embodiment 2 | 32 | 555 | 710 | 25 | 0.78 |
| | | 550 | 710 | 24 | 0.77 |
| Embodiment 3 | 32 | 545 | 690 | 26 | 0.79 |
| | | 555 | 690 | 24 | 0.8 |
| Embodiment 4 | 65 | 535 | 710 | 24 | 0.75 |
| | | 540 | 700 | 22 | 0.77 |

TABLE 2
Impact Properties

| | | Impact | | |
|---|---|---|---|---|
| | | | | Percentage |
| | | | | of ductile |
| | Thickness, | Temper- | Impact | fracture |
| Embodiment | mm | ature/° C. | value/J | surface (%) |
| Embodiment 1 | 16 | −23 | 290 | 97 |
| | | −40 | 292 | 100 |
| | | −60 | 270 | 92 |
| Embodiment 2 | 32 | −23 | 313 | 100 |
| | | −40 | 285 | 100 |
| | | −60 | 267 | 100 |
| Embodiment 3 | 32 | −23 | 264 | 100 |
| | | −40 | 263 | 100 |
| | | −60 | 238 | 100 |
| Embodiment 4 | 65 | −23 | 277 | 97 |
| | | −40 | 243 | 93 |
| | | −60 | 197 | 82 |

TABLE 3
NDT Test Results

| | | | |
|---|---|---|---|
| Embodiment | Thickness, mm | Temperature | Test results |

| | | |
|---|---|---|
| Embodiment 1 | 16 | No NDT test |

| | | | |
|---|---|---|---|
| Embodiment 2 | 32 | −40 | No fracture |
| | | −55 | No fracture |
| | | −60 | Fracture |
| Embodiment 3 | 32 | −40 | No fracture |
| | | −55 | No fracture |
| | | −60 | Fracture |
| Embodiment 4 | 65 | −40 | No fracture |
| | | −45 | No fracture |
| | | −50 | Fracture |

As shown in FIG. 1 and FIG. 2, the structures in Embodiments 1 and 2 do not contain any large-grained MA island structure, but contain a small amount of ferrite in addition to granular bainite. Such a structure allows the steel plate to maintain beneficial plasticity and toughness with sufficient strength, while maintaining the low yield strength ratio of the steel. The data in Tables 1-3 show that the mechanical properties of Embodiments 1 and 2 produced by use of the preparation method of the present invention can reach the design level: the yield strength is between 500 MPa and 600 MPa, the elongation is ≥20%, the yield strength ratio is ≤0.85, the impact energy at −23° C. is ≥240 J, and the non-plastic transition temperature of T_{NDT} is −50° C.

What is claimed is:

1. A micro-molybdenum-type weathering bridge steel plate, wherein the steel plate is smelted from the following components by weight: C: 0.05-0.08%, Si: 0.30-0.50%, Mn: 1.25-1.35%, P: 0.010-0.014%, S≤0.003%, Nb: 0.020-0.030%, Ti: 0.010-0.020%, V: 0.040-0.050%, Cu: 0.25-0.40%, Ni: 0.25-0.35%, Cr: 0.45-0.55%, Mo: 0.03-0.08%, Alt: 0.020-0.040%, and the balance from Fe and impurities.

2. The micro-molybdenum-type weathering bridge steel plate according to claim 1, wherein the steel plate is composed of granular bainite and ferrite structures.

3. A method for preparing the micro-molybdenum-type weathering bridge steel plate according to claim 1, wherein the method comprises smelting, continuous casting, heating, rolling, and tempering; the rolling process is two-stage rolling; the rough rolling (RR) temperature is 950-1150° C., and the initial rolling temperature (IRT) and the finishing rolling temperature (FRT) of finish rolling (FR) are 850-900° C. and 800-850° C., respectively; and after hot rolling, the steel plate is cooled by laminar flow, and the cooling rate is 5-20° C./s.

4. The method for preparing the micro-molybdenum-type weathering bridge steel plate according to claim 3, wherein the continuous casting process is a casting process of dynamic soft reduction.

5. The method for preparing the micro-molybdenum-type weathering bridge steel plate according to claim 3, wherein the smelting process comprises Ladle Furnaces (LF) refining process and Ruhrstahl Heraeus (RH) vacuum treatment process.

6. The method for preparing the micro-molybdenum-type weathering bridge steel plate according to claim 3, wherein the heating temperature of a casting blank in the heating process is 1160-1200° C., and heating is performed in a furnace for 235-350 min.

7. The method for preparing the micro-molybdenum-type weathering bridge steel plate according to claim 3, wherein the tempering temperature is 500-550° C., and the tempering time is 50-150 min.
